(19) United States
(12) Patent Application Publication
(10) Pub. No.: US 2014/0281650 A1
(43) Pub. Date: Sep. 18, 2014

(54) PASSIVE MONITORING SYSTEM

(71) Applicant: Evermind, Inc., Nashville, TN (US)

(72) Inventors: David Allen GILBERT, Nashville, TN (US); Dustin G. Withers, Nashville, TN (US); Don Lee David Stratton, Nashville, TN (US); Joshua Alan Sharpe, New Brighton, MN (US); Kip Andrew Lindsay, Hermitage, TN (US); George Anderson Cook, IV, Nashville, TN (US); Helen Rae Sherwood Stevens, Nashville, TN (US)

(73) Assignee: Evermind, Inc., Nashville, TN (US)

(21) Appl. No.: 14/213,524

(22) Filed: Mar. 14, 2014

Related U.S. Application Data
(60) Provisional application No. 61/789,026, filed on Mar. 15, 2013.

(51) Int. Cl. G06F 1/26

(52) U.S. Cl. CPC G06F 1/26
USPC 713/340

(57) ABSTRACT

Embodiments discussed herein provide a passive monitoring system for use in a residential independent living framework. In some exemplary embodiments, the system may be used to alert a primary caregiver of a possible decline or change in an activity of daily living (“ADL”) of the monitored individual. The system may collect usage data associated with, for example, electrical devices at the living quarters of the monitored individual. The collected data may include data pairs of time samples and voltage data associated with one or more electrical devices that the monitored individual is expected to utilize. Applying various filters to the collected data, a possible decline or change in ADL of the monitored individual may be identified.

### RELATED APPLICATIONS

The present application claims priority to a United States provisional application, Patent Application No. 61/789,026, filed Mar. 15, 2013, the contents of which are incorporated herein by reference.

### BACKGROUND

Caregivers of elderly people or people with physical disabilities often would like to know that the people in their care are carrying on their daily activities. Currently, there are systems that help monitor seniors in their home. Most of the current monitoring technologies have means to alert a help center when there is an emergency. For example, devices that can be worn as a pendant have buttons that, when activated, alert a call center. An operator at the call center talks to the senior through a speakerphone device and assesses the situation. If the operator determines that there is an emergency, the call center may dispatch emergency medical assistance to the senior's living quarters.

However, the current monitoring technologies do not monitor the daily activities of individuals to confirm that the monitored individual is carrying out their normal daily activities. The conventional monitoring systems become effective or useful when there is an emergency. Thus, there is a need for a system that will monitor individuals without being intrusive to confirm that the monitored individual is carrying out their routine activities of daily living.

### SUMMARY

Methods and systems are provided for monitoring daily activities of individuals to confirm that the monitored individual is carrying out their normal daily life. An exemplary system described herein may include one or more nodes for monitoring one or more appliances used on a habitual basis by the individual. The nodes may be coupled to the appliances and may collect power usage information of the appliances. The nodes may communicate with a remote server to relay the collected power usage information. The collected power usage information may be used to determine actual activities of the individual. The remote server may also receive data from users, e.g. caregivers of the monitored individual, establishing expected activities of the monitored individual. When a disparity is detected between the actual activities and the expected activities, a notification may be generated and sent to the users. In some embodiments, the users may define notification threshold levels such that the notification is generated when the disparity is above a certain threshold.

Various embodiments provide a system for monitoring one or more activities of an individual. The system may include one or more nodes for collecting power usage information at living quarters of the individual. The system may also include an interface for a user to provide a notification request when one or more actual activities occur. The use may also specify, via the interface, one or more expected activities and one or more notification threshold levels. The system may further include a processing engine and a notification engine. The processing engine may determine the one or more actual activities of the individual based on the power usage information, and compare the one or more actual activities to the one or more expected activities. The notification engine may generate one or more notification messages when the one or more actual activities occur that match the notification request, and a difference between the one or more actual activities and the one or more expected activities is outside the one or more notification threshold levels.

In some embodiments a method is provided for monitoring one or more activities of an individual. The method may include receiving monitoring data from one or more nodes collecting power usage information at living quarters of the individual. The method may also include determining actual activities of the individual based on the monitoring data. The method may further include receiving notification request for one or more of the actual activities of the individual. Information about or specification of one or more expected activities for the individual may be received. The actual activities may be compared to the one or more expected activities. A notification may be generated based on the comparing or the notification request.

Various embodiments provide a non-transitory computer-readable storage medium storing instructions that, when executed on a processor, cause the processor to receive monitoring data from one or more nodes collecting power usage information at a living quarters of an individual. The instructions may also cause the processor to determine actual activities of the individual based on the monitoring data. Notification request for one or more of the actual activities of the individual may be received. Further, information about or specification of one or more expected activities for the individual may be received. The instructions may cause the processor to compare the actual activities to the one or more expected activities and detect, based on the comparing, a disparity between the actual activities and the one or more expected activities. The disparity may be compared to the one or more notification levels prior to generating the notification associated with the disparity. A notification associated with the disparity may be generated based on the comparing or the notification request.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates an overview of an exemplary system;

FIG. 2A illustrates an exemplary LAN/WAN node and components thereof;

FIG. 2B illustrates a front view and a back view of a top cover of the exemplary LAN/WAN node;

FIG. 2C illustrates a front view and a back view of a bottom cover of the exemplary LAN/WAN node;

FIG. 2D illustrates a first view of the assembled LAN/WAN node;

FIG. 2E illustrates a second view of the assembled LAN/WAN node;

FIG. 3A illustrates components of a first node as an LAN/WAN node in a three-node system according to an embodiment;

FIG. 3B illustrates an assembled view of the first node;

FIG. 4A illustrates components of a second node as a LAN node in the three-node system;

FIG. 4B illustrates an assembled view of the second node;

FIG. 5A illustrates components of a third node as a LAN node in the three-node system;

FIG. 5B illustrates an assembled view of the third node;

FIG. 6 illustrates exemplary methods for configuring one or more nodes of an exemplary system;

FIG. 7 illustrates an exemplary software application associated with the exemplary system illustrated in FIG. 6;

FIG. 8A illustrates how a LAN node measures power levels using a current sensor;

FIG. 8B illustrates how an LAN/WAN node measures power levels using a current sensor;

FIG. 9 illustrates screenshots from an exemplary mobile application;

FIG. 10 illustrates a flowchart of exemplary steps for monitoring an individual according to various embodiments; and

FIG. 11 illustrates an exemplary electronic device that may be suitable for use with one or more acts disclosed herein.

### DETAILED DESCRIPTION

Embodiments discussed herein provide a passive monitoring system for use in a residential living framework. In some exemplary embodiments, the system may be used to alert a caregiver of a possible decline or change in an activity of daily living (“ADL”) of the monitored individual. For example, the system may collect power usage data associated with, for example, electrical devices at the living quarters of the monitored individual. The collected data may include data pairs of time samples and voltage data associated with one or more electrical devices that the monitored individual is expected to utilize. Applying various filters to the collected data, a possible decline or change in ADL of the monitored individual may be identified using, for example, co-variant analysis.

According to various embodiments, the use of a particular household electrical appliance may be representative of an ADL. Using current flow (e.g. changes in power usage), the system may determine whether a specific appliance is used within a specific time period to match with a known pattern of the monitored individual. A system user may designate at least one appliance in the living quarters of the individual to be monitored by the system. If the system senses a failure to use the designated appliance during the prescribed period, the system may send an alert notification to the caregiver. Exemplary designated appliances may include one or more of a coffee maker, television, lamp, microwave oven, toaster, electric kettle, stereo, radio, hair dryer, garage door opener, etc. However, designated appliances are not limited to the foregoing and may include other appliances. For example, in some exemplary embodiments, medical devices may be monitored to determine compliance with clinical directive. Exemplary medical devices may include one or more of a home dialysis machine, a continuous positive airway pressure (CPAP) machine, and oxygen concentrator, a home chemotherapy pump, and a constant passive motion (WPM) device.

The system described herein avoids being intrusive and aims to balance the privacy needs of a monitored individual with the needs of a caregiver for actionable knowledge. To this end, embodiments discussed herein seek to provide a caregiver with an ambient awareness of an individual's instrumental ADLs without allowing the caregiver to spy on the individual. As such, the system does not require a video camera and/or a motion sensor for functioning, i.e. the system functions as intended without the presence of a video camera and/or a motion sensor. However, the system described herein may be coupled with a video camera and/or a motion sensor if needed or desired.

FIG. 1 illustrates an overview of an exemplary system 100. The system 100 may include one or more nodes 102 provided in the monitored individual's living quarters. The system 100 may be set up by plugging the nodes 102 into wall power sockets/outlets such that the nodes 120 are in-line with electrical appliances, e.g. home appliances or medical devices, plugged into the same wall power sockets/outlets. The electrical appliances are those that are known to be used by the monitored individual on a regular basis. Each node 102 includes a current sensor, which is discussed below in greater detail in connection with FIGS. 2A-2E.

According to various embodiments, the node 102 may collect power usage information of the electrical appliances in the monitored individual's living quarters. The electrical appliance is coupled to the power outlet via the node 102. For example, collecting the power usage information may include measuring the current flow at the power outlet where the node 102 is coupled. The power usage information may also include ON switching events, OFF switching events, the number of ON/OFF switching events and the times of the ON/OFF switching events associated with an electrically powered device/appliance plugged into the power outlet where the node 102 is coupled. In some embodiments, the number of ON/OFF switching events may be analyzed to determine machine-initiated switching events. The machine-initiated switching events may be filtered out from the number of ON/OFF switching events to determine switching events actually initiated by the monitored individual.

Various embodiments may allow the system to determine the type of the appliance used based on the number of ON/OFF switching events and the times of the ON/OFF switching events. For example, single-cup coffee makers could have short events spaced around 30 minutes apart with durations of use. The number of ON/OFF switching events and durations between the ON/OFF switching events could be used to gain further information from the events instead of ignoring the events.

According to various embodiments, the system may be able to detect the distinction between “thermostatic OFF” and “final OFF” of an appliance. Both the “thermostatic OFF” and “final OFF” may be initiated by the appliance. However, the “final OFF”, even if machine-initiated, may still be important. In some exemplary embodiments, the system may determine, based on the appliance-initiated “final OFF” events after a period of thermostatic cycling, that the appliance is in the middle of a cycle that can include periods of very low power. The system may also determine when the appliance has returned to an idle or off state.

The power usage information may also include the time and/or duration of ON/OFF switching states associated with an electrical-power device/appliance plugged in the power outlet where the node 102 is coupled. For example, a home dialysis machine may be plugged in the power outlet where the node 102 is coupled. The power usage information may indicate whether the individual used the home dialysis machine for the required amount of time with or without interruptions. Accordingly, the node 102 may be used to ensure that the individual complies with the medical requirements of his/her treatment by ensuring that the individual uses the home dialysis machine for the required, i.e. prescribed, amount of time.

In some embodiments, the power usage information collected by the node 102 may include profiling information based on particular power signatures associated with electric-powered devices. For example, a CPAP machine may be connected to a power source through a node. The power usage information may indicate breathing activity as determined by the air pressure setting of the CPAP machine based on the particular power signature associated with the CPAP machine when such activity occurs.

Referring back to FIG. 1, users 104, such as caregivers of the monitored individual, may configure monitoring criteria for the ADL of the monitored individual through an software application 106. For example, the software application 106 may allow the users 104 to set the temporal parameters of expected electrical switching and/or usage activity for each of the home appliances or medical devices connected to power plugs though each of the nodes. The web application 106 may allow the users 104 to specify the conditions under which the users 104 wish to receive alert messages related to the monitored individual's use of the appliances.

The users 104 may configure the entire system according to their preferences. For example, the users 104 may configure the system to indicate the activity level expected from the monitored individual. The configurations may be different for monitoring a senior and a handicapped individual as the expected activities and frequency of the activities may vary according to the physical abilities of the monitored individual. The users 104 may also configure the system to indicate a sensitivity level such as a threshold. For example, the system 100 may be set up to expect a coffee maker to get activated at 8 am. The user may indicate that a 30 min delay is acceptable. Thus, the system may not alert the user until 8:31 am when the coffee maker is not activated.

For example, for each of the home appliances the user chooses to connect to a node 102, the user may define a region of time in which a switching event, e.g. on/off, is expected using the web application 106. For example, the user 104 may know that the monitored individual typically turns the bedside lamp on/off between 9 pm and 11 pm. The user 104 may accordingly configure the system 100 so that if the system 100 does not detect a switching event within the defined time window, the system 100 will send the user 104 a message. These time windows can be set differently for each connected home appliance, and differently for each day of the week. The interface the user may use to configure the system may be familiar to a user of desktop or online calendar applications. An exemplary interface 700 is discussed in greater detail in connection with FIG. 7.

Based on the configuration, an event logging system 108 may monitor the ADL of the monitored individual through nodes 102. The event logging server 108 may store the collected monitoring information received by the nodes 102 at a datastore 110. The users 104 may access the datastore 110 for reviewing the monitoring information. In some embodiments, the datastore 110 may include a Structured Query Language (SQL) database.

A processing engine 112 may access the monitoring data collected by the event logging server 108 and compare the monitoring data to the monitoring criteria set by the users 104. If the processing engine 112 determines a mismatch or a disparity between the monitoring data and the monitoring criteria, the processing engine 112 may notify the notification server 114.

In some embodiments, the processing engine 112 may analyze the monitoring data to determine one or more of a change in activity patterns of the individual, an increase or decrease in the activity of the individual, a magnitude of variability in use of electronic technologies, an interval of time between activities of the individual, and general mobility of the individual in the living quarters. The processing engine 112 may generate a graphical representation, such as an event card, for one or more of the foregoing criteria. The processing engine 112 may provide the graphical representation(s) to the web application 106 so that authorized users 104 can access the graphical representation(s). For example, an event card may be generated to illustrate each of the following: the change in activity patterns of the individual, the increase or decrease in the activity of the individual, the magnitude of variability in use of electronic technologies, the interval of time between activities of the individual, and the general mobility of the individual in the living quarters.

In some embodiments, the power consumption baseline for an electrical appliance may be established to distinguish between “on” and “off” modes. A current sensor and microprocessor with memory may observe and record the baseline power draw of a given appliance over time to determine when the device is switched “on” or “off.” The average power consumption after a drop from a baseline may be counted as the new “off” baseline. The processing engine 112 may determine, based on the received monitoring data, a sharp increase in power draw in connection with an appliance. The processing engine 112 may readjust the notification threshold level associated with the appliance based on the identified sharp increase. As such, the processing engine 112 may determine and account for idle power draw by the appliances like television sets.

For example, a television may draw power of about 20 Watts when the television is turned off. The notification threshold level associated with the television may be 15 Watts. Accordingly, when the received monitoring data indicates 300 Watts drawn by the television, the processing engine 112 may interpret the television as being “on”. When the monitored individual actually turns the television on, the measured power draw may increase to about 300 Watts. The processing engine 112 may detect that the new measured power draw is much greater the previous power draw value of 20 Watts. Accordingly, the processing engine 112 may change the notification threshold level associated with the television to be higher than the initial threshold value. For example, the new threshold value may be chosen to be between the initial measured power draw (20 Watts) and the new measured power draw (300 Watts). Thus, when the monitored individual turns the television off, the power draw decreases to the idle state value of about 20 Watts. Since this value is below the new threshold value set for the television, the processing engine 112 interprets the television as being turned off.

In some embodiments, the power usage information collected by the node 102 may be used to determine that a thermostat-based electrical appliance is switched off. For example, the collected power usage information may indicate that a coffeemaker did not draw power for a given amount of time, e.g. 10 min., after the coffeemaker has been switched on. Based on this information, the processing engine may determine that the coffeemaker is now switched off.

Appliances may draw a fixed amount of power when the appliances are switched “on”. Devices based on thermostatic controls (e.g., devices which heat up and maintain a specific temperature range such as heating pads, coffee makers, etc,) may draw power in bursts. For example, when a heating pad is turned on, an internal thermometer of the heating pad may determine that the pad is below the target temperature. Upon such determination, the heating pad draws full power tier a given amount of time, e.g. about 5 minutes, and applies the power to the heating elements until the internal thermometer detects that the pad is at or above the target temperature. The heating pad then stops applying power to the heating elements until the internal thermometer detects that the pad is below the target temperature. When the pad is below the target temperature, the heating pad applies power to the heating elements until the target is reached again. The process may continue for as long as a control unit of the heating pad is set to one of the “on” positions, or until a separate timeout is reached (e.g. if there is a safety measure to turn off the device after a few hours of operation). A power monitoring system would normally be unable to detect the extremely small amount of electricity being drawn to power the control pad of the heating pad. Thus, when the thermostatic control system stops applying power to the heating elements, the electrical consumption may drop below the lower threshold of the power detection circuit. This may cause the heating pad to appear to be “off” even though the control system and the heating cycle are still on. If it can be determined that a thermostatic system is being used, an algorithm may be implemented to dynamically adapt to the unusually high number of on-off cycles and to smooth the on-off cycles into a single period of use that lasts for the duration of the operation of the appliance.

According to various embodiments, the users 104 may configure the system 100 to receive activity notifications, i.e. when a designated event happens, and/or inactivity notifications, i.e. when a designated event does not happen. Referring back to FIG. 1, the notification server 114 may send a message to the users 104 via email 116 or short messaging service (SMS) 118 using, for example, a cell phone network 120. The notification server 114 may notify the users 104 by, for example, sending text messages and/or emails, when monitored home appliances are not electrically switched within the specified temporal parameters. The message sent from the notification server 114 may indicate a decline or an anomaly in the ADL of the monitored individual. One of ordinary skill in the art will appreciate that the notifications sent to the users are not limited to text messages or email, and that the users may be notified using other forms of communication, such as a phone call, an automated voice message, a beeper message, etc.

In some embodiments, in respect of the privacy of the monitored individual, and to curtail the number of alert messages produced, the system may not notify the caregiver of every instance of on/off switching, but rather may notify the user of the non-occurrence of on/off switching events over a specified period of time. In yet other embodiments, the notification server 114 may notify the users 104 by, for example, sending text messages and/or emails, when monitored home appliances are electrically switched within the specified temporal parameters to indicate that the monitored individual is following her/his routine. Independently of the notification messages, the users 104 may access the web application 106 to monitor the received monitoring data.

As illustrated in FIG. 1, the communication among the nodes 102, the event logging server 108, the web application 106, the notification server 114 and the users 104 may be provided, among other options, via a network 105.

According to various embodiments, one or more nodes 102 may be employed to track the ADL of the monitored individual. Each of the nodes 102 may be active or passive. When a plurality of the nodes is employed, at least one of the nodes must be an LAN/WAN node. The LAN/WAN node communicates with the event logging server 108 and the LAN nodes.

FIGS. 2A-2E illustrate an exemplary LAN/WAN node 200 and components thereof.

As illustrated in FIG. 2A, the LAN/WAN node 200 includes a top cover 201 and a bottom cover 202 enclosing a plurality of components. FIG. 2B illustrates a front view 222 and a back view 224 of the top cover 201. FIG. 2C illustrates a front view 226 and a back view 228 of the bottom cover 202. Components such as board assembly 204 (i.e. LAN RF components and system indicator LEDs), one or more light bumps 206, main board assembly 208, wireless transceiver 209 and cell antenna 210 are provided in an enclosure formed when the top cover 201 and the bottom cover 202 are fitted together. FIG. 2D illustrates a first view 250 of the assembled LAN/WAN node 200 enclosing the foregoing components. FIG. 2E illustrates a second view 252 of the assembled LAN/WAN node 200 enclosing the foregoing components.

Referring back to FIG. 2A, the top cover 201 includes one or more openings 212 to correspond to the one or more light bumps 206. The one or more openings 212 allow the lights of the one or more light bumps 206 to be visible when the LAN/WAN node 200 is plugged into an electrical wall outlet. Board assembly 204, one or more light bumps 206, main board assembly 208, wireless transceiver 209 and cell antenna 210 may be coupled to the bottom cover 202 via fastening means 214 and 216, such as screws. The LAN/WAN node 200 may further include electrical prongs 218 to connect the LAN/WAN node 200 to an electrical wall outlet. The bottom cover 202 may include openings 227 for the electrical prongs 218 to fit through. The LAN/WAN node 200 may further include a ground pin 220. The bottom cover 202 may include an opening 229 for the ground pin 220 to fit through. A pass-through power plug 205, similar to an electrical wall outlet, is provided on the top cover 201 of the LAN/WAN node 200. The designated appliance may be connected to the wall outlet via the pass-through power plug 205.

In some exemplary embodiments, the node 102 may include an inline light bulb power sensor that is installed between a standard light socket and a light bulb. Various embodiments may provide the node 102 with a power sensor inline with a modular battery in a cordless appliance. For example, the inline power monitoring device may be an inline battery power sensor that is installed between a standard battery (e.g., D-cell, C-cell, AA, AAA) and a battery powered appliance such as a television remote control, flashlight, or garage door opener.

As provided above, according to various embodiments, more than one node 102 may be used to track the ADL of the monitored individual. Each node 102 may be connected to a different designated appliance and/or medical device. For example, three nodes 102 may be used in connection with a first designated appliance that the monitored individual is expected to use in the morning, a second designated appliance that the monitored individual is expected to use at midday and a third designated appliance that the monitored individual is expected to use in the evening, respectively. Even when a plurality of nodes 102 are employed, only one of the plurality of nodes 102 may be provided with the cell antenna 210 and the main board 208 for communicating with remaining current sensors 102 and the event logging server 108, i.e. only one of the plurality of nodes 102 is an LAN/WAN node. If more than one nodes 102 are employed, each node 102 may be identified with a unique mark. For example, each node may include a different number of light bumps.

FIGS. 3A-5B illustrate three nodes used in an exemplary embodiment.

FIGS. 3A-3B illustrate a first node. As shown in FIG. 3A, the first node 300 may be provided with a single light bump 302. The first node 300 includes a current sensor 310 and a wireless transceiver 312 to communicate with other nodes. The first node 300 may communicate with the other nodes via a local area network (LAN) bridge. In addition, the first node 300 includes the cell antenna 306 and the main board 308 for communicating with a remote server, such as the event logging server 108, via a wide area network (WAN) bridge. Accordingly, the first node 300 is an LAN/WAN node. The assembled first node 300 is illustrated in FIG. 3B.

FIGS. 4A-4B illustrate a second node. As shown in FIG. 4A, the second node 400 may be provided with two light bumps 402. The second node 400 includes a current sensor 410 and a wireless transceiver 412 to communicate with other nodes. The second node 400 may communicate with the other nodes via a LAN bridge. Since the cell antenna 306 and the main board 308 are already provided in the first node 300, the second node 400 does not include a cell antenna and/or a main board. Accordingly, the second node 400 is a LAN node. The assembled second node 400 is illustrated in FIG. 4B.

FIGS. 5A-5B illustrate a third node. As shown in FIG. 5A, the third node 500 may be provided with three light bumps 502. The third node 500 includes a current sensor 510 and a wireless transceiver 512 to communicate with other nodes. The third node 500 may communicate with the other nodes via a LAN bridge. Since the cell antenna 306 and the main board 308 are already provided in the first node 300, the third node 500 does not include a cell antenna and/or a main board. Accordingly, the third node 500 is a LAN node. The assembled third node 500 is illustrated in FIG. 5B.

FIG. 6 illustrates two exemplary methods for configuring the nodes 102 of the system. The system may include, among other components, a plurality of (e.g. three) 120 V AC nodes 102. The current sensors of the nodes 102 may take time samples of the current and may filter out quiescent levels of power. As provided above, the nodes 102 may include pass-through power plugs (“wall warts”) and wireless transceivers. The transceivers allow the nodes to establish a mesh network and communicate with each other. According to a first exemplary configuration 600, the nodes 102 may include a label illustrating the specific appliance that is connected to each node 102. According to a second exemplary configuration 620, the nodes 102 may be associated with an online web portal, such as the software application 106, where each node 102 may be defined in terms of the specific appliance connected to the given node 102. The details of software application 106 are illustrated are FIG. 7.

Referring to FIG. 7, the software application 106 may include a setup user interface 700 for configuring and monitoring the system. The user interface 700 may include a plurality of panes 701, 702, 704,706. For example, pane 701 may be an identification pane that provides information about the given system, such as identification number. Panes 702, 704, 706 may each correspond to a respective node included in the system. Panes 702, 704, 706 may allow the user to configure and monitor the nodes of the system. The exemplary system illustrated in FIG. 7 may include three nodes which can be configured through panes 702, 704, 706, respectively. Panes 702, 704, 706 may receive user input that indicates the location of the node. For example, the user may indicate that node 1 is provided in the kitchen by entering “kitchen” in space 708. The user may also indicate that node 1 is a lamp by checking the box 710 next to the lamp option.

One of ordinary skill in the art will appreciate that the user interface 700 provided in FIG. 7 is for illustration purposes and that the user may configure the system using an alternative interface. The system with three nodes is provided for illustration purposes and should not be construed as limiting. The system may include as many nodes as necessary so long at least one of the nodes is an LAN/WAN node.

According to various embodiments, one of the power plugs may be designated as the master plug, i.e. coupled to the LAN/WAN node. For example, in the exemplary system illustrated in FIG. 7, current sensor 1 illustrated in pane 702 may be indicated to be the master plug, i.e. the active sensor, (as indicated by textual description 712). The master plug, i.e. the LAN/WAN node, may include a GSM/GPRS, CDMA, other cellular modem or other Internet or network interface for communicating data from all of the nodes to a remote server, such as event logging server 108. The collected data may be stored at a database, such as datastore 110, in communication with the remote server.

FIG. 8A illustrates how a LAN node 800 measures power levels using a current sensor 801. The current sensor 801 may be interfaced to a microprocessor 802 through an analog-to-digital (A/D) converter to monitor the current flow. The microprocessor 802 and supporting circuitry may be powered by a switch-mode power supply 804 that draws very little power while operating. The microprocessor 802 may continuously register current flow levels as detected by current sensor 801. The collected current flow levels may be transmitted to the “master” node, i.e. the LAN/WAN node, through the mesh-networked transceiver 806 of the LAN node 800.

FIG. 8B illustrates how an LAN/WAN node i.e. master node, 820 measures power levels using a current sensor 822. The current sensor 822 may be interfaced to a microprocessor 824 through an analog-to-digital converter to monitor the current flow. The microprocessor 824 and supporting circuitry may be powered by a switch-mode power supply 826 that will draw very little power while operating. The microprocessor 802 may continuously register current flow levels as detected by current sensor 801. The LAN/WAN node 820 may include a transceiver 828 that is interfaced to the microprocessor 824. The transceiver 828 may allow the LAN/WAN node 820 to communicate with LAN nodes, such as the LAN node 800, within reception range of the LAN/WAN node. The LAN/WAN node 820 may receive collected current flow information from the LAN nodes, such as the LAN node 800. The LAN/WAN node 820 may send the current flow information received from other nodes as well as the current flow information collected the LAN/WAN node 820 to a remote server. The LAN/WAN node 820 may communicate with the remote server using a Global System for Mobile Communications (GSM) and/or General Packet Radio Service (GPRS) module 830, i.e., the cellular modem. The module 830 may post these data to the remote server via an HTTP POST command through a wireless cellular network connection.

According to various embodiments, the users may configure the system using a mobile application. FIG. 9 illustrates a number of screenshots from an exemplary application 900.

The web architecture associated with the system may be a service oriented architecture that leverages a REST-ful interface to receive data from the deployed system. All events may be logged and stored in an Atomicity, Consistency, Isolation, Durability (ACID) compliant transactional database. Users may register with the system using a registration interface 902. The users may also identify a master device/appliance. Registration of the master device/appliance may be accomplished through a traditional desktop website or a mobile-optimized website.

Upon completion of registration, the system may prompt users to select and assign devices through a drag-and-drop interface that uses HTML5 and Cascading Style Sheets (CSS) technologies, as illustrated in exemplary interface 904.

Events may be viewable in real-time via Asynchronous JavaScript and XML (AJAX) long-polling of data that are received from the master device. Icons may be activated when an associated electrical appliance is in use. The real-time visibility may enable a user to verify that the user has successfully set up the system.

The user is able to enter scheduling data for each of the devices using a software interface, such as interface 906. According to exemplary embodiments, the schedule interface 906 may be a row-and-column based display that provides a grid of days and time slots. The schedule will enable the system to alert the user should an electrical on/off switching event fail to occur during an expected time-frame.

One of ordinary skill in the art will appreciate that the application 900 provided in FIG. 9 is for illustration purposes and that the application may be designed to have a different layout and/or user interface.

Upon reception of an event from a master device, the system may look up the ID of the device and cross-check against the schedule. Notifications (alerts) may be sent if an event does not happen during a scheduled block of time. To this end, the system may build a look-up table of time slots. When an event is received during that time slot, the system may mark time slot as fulfilled. If, at the completion of a time slot, no event has been received that is concurrent with the time slot, then a notification may be generated.

Time slot completion may be maintained via an event queue pump that may always be filled with the latest time slots. The primary job of the system is to identify time slots that have not been fulfilled, i.e. identifying an expected activity that did not occur, and to generate notifications appropriately. Notifications may be sent to email addresses and mobile phone numbers provided by users. In the case of mobile phone numbers, the system may generate and send Short Message Service (SMS) message alerts.

The system may be associated with a server-side pairing of a local ad hoc network. A method for connecting the ad hoc network of wireless sensors may be established without hardware pairing. A sensor may connect to a remote server by connecting to any node in range, regardless of whether that node is part of the intended network. After the sensor connects, the server may identify the sensor and, if necessary, instruct the sensor to connect to a different node that is part of the intended network.

In some embodiments, electrical current draw of an electrical appliance may be measured using redundant sensors. A power sensor may use both a shunt and hall effect current sensor and compare the results of both to determine whether an electrical appliance is “on” or “off.”

According to various embodiments discussed herein, a user may be notified of a remote electrical appliance switching event. The events are logged on a remote server. At the time of logging, the associated user account is checked to see if the user wants immediate notification of the switching event. Rate limiting may be used to filter notifications from certain appliances that have an automatic or timed shut-off mode, e.g., a coffee maker, toaster, or microwave oven. Knowledge of electrical appliance switching activity (“on” or “off”) and appliance type may be used to provide contextually relevant information to the user. Contextually relevant information can include, but is not limited to information related to usage patterns, activity and overall activity level; information related to appliance type and/or location in the home; general information related to health and wellness. Based on the collected information, significant activity patterns, routines and deviations based on switching activity, appliance type, time and location may be identified.

FIG. 10 illustrates an exemplary flowchart 1000 of steps that may be performed in monitoring an individual's ADL. As provided above, the ADL of the individual may be monitored using one or more nodes that collect power usage information at the living quarters of the individual. The system may receive the monitoring data from the one or more nodes (step 1002). Actual activities of the individual may be determined based on the received monitoring data (step 1004). For example, using the received monitoring data, the monitoring system may determine that the individual turned on the coffeemaker, the television, etc. or started using the home dialysis machine. The system may also receive one or more expected activities and notification threshold levels for the individual (step 1006). The expected activities and notification threshold levels may be provided by the users, e.g. caregivers of the individual. The system may compare the actual activities to the one or more expected activities (step 1008). A disparity between the actual activities and the one or more expected activities may be detected based on the comparing (step 1010). The disparity may be compared to the one or more notification levels (step 1012). The system may generate a notification, for example, when the disparity exceeds the notification level(s) (step 1014). In some embodiments, the notification may be associated with the disparity, e.g. inactivity notifications. In yet other embodiments, the notification may be generated even when a disparity is not identified, e.g. activity notifications confirming that the individual performed the expected activity within the expected time frame.

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 11 depicts an example of an electronic device 1100 that may be suitable for use with one or more acts disclosed herein.

The electronic device 1100 may take many forms, including but not limited to a computer, workstation, server, network computer, quantum computer, optical computer, Internet appliance, mobile device, a pager, a tablet computer, a smart sensor, application specific processing device, etc.

The electronic device 1100 is illustrative and may take other forms. For example, an alternative implementation of the electronic device 1100 may have fewer components, more components, or components that are in a configuration that differs from the configuration of FIG. 11. The components of FIG. 11 and/or other figures described herein may be implemented using hardware based logic, software based logic and/or logic that is a combination of hardware and software based logic (e.g., hybrid logic); therefore, components illustrated in FIG. 11 and/or other figures are not limited to a specific type of logic. The electronic device 1100 may be used to implement one or more components illustrated in FIG. 1. For example, one or more electronic device(s) 1100 may be used to implement one or more of event logging server 108, datastore 110, web application 106, processing engine 112 and notification server 114.

The processor 1102 may include hardware based logic or a combination of hardware based logic and software to execute instructions on behalf of the electronic device 1100. The processor 1102 may include logic that may interpret, execute, and/or otherwise process information contained in, for example, the memory 1104. The information may include computer-executable instructions and/or data that may implement one or more embodiments of the invention. The processor 1102 may comprise a variety of homogeneous or heterogeneous hardware.

The electronic device 1100 may include one or more tangible non-transitory computer-readable storage media for storing one or more computer-executable instructions or software that may implement one or more embodiments of the invention. The non-transitory computer-readable storage media may be, for example, the memory 1104 or the storage 1118. The memory 1104 may comprise a ternary content addressable memory (TCAM) and/or a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

The electronic device 1100 may include a network interface 1108 to interface to a LAN, WAN or the Internet through a variety of connections including, but not limited to, standard telephone lines, LAN or WAN links (e.g., T1, T3, 46 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 1108 may include a built-in network adapter, network interface card, personal computer memory card international association (PCMCIA) network card, cardbus network adapter, wireless network adapter, universal serial bus (USB) network adapter, modem or any other device suitable for interfacing the electronic device 1100 to any type of network capable of communication and performing the operations described herein.

The electronic device 1100 may include one or more input devices 1110, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 1100 may include other suitable I/O peripherals.

The input devices 1110 may allow a user to provide input that is registered on a visual display device 1114. A user interface (UI) 1116 may be shown on the display device 1114. For example, the users 104 may provide expected activities, time frames for the expected activities and one or more threshold levels using the input devices 1110.

A storage device 1118 may also be associated with the computer 1100. The storage device 1118 may be accessible to the processor 1102 via an I/O bus. The information may be executed, interpreted, manipulated, and/or otherwise processed by the processor 1102. The storage device 1118 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 1118 may further include a datastore 110 for storing collected monitoring information. The storage device 1118 may store applications 1124, including the web application 106, and an operating system (OS) 1126 for running on the electronic device 1110. Examples of OS 1126 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such.

Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

1. A system for monitoring one or more activities of an individual, the system comprising:
one or more nodes for collecting power usage information at a living quarters of the individual;
an interface for a user to:
provide a notification request when one or more actual activities occur;
specify one or more expected activities and one or more notification threshold levels;
a processing engine for:
determining the one or more actual activities of the individual based on the power usage information, and
comparing the one or more actual activities to the one or more expected activities; and
a notification engine for generating one or more notification messages when:
the one or more actual activities occur that match the notification request, and
a difference between the one or more actual activities and the one or more expected activities is outside the one or more notification threshold levels.

2. The system of claim 1, further comprising:
an event logging server wirelessly coupled to at least one of the one or more nodes for logging the collected power usage information.

3. The system of claim 2, wherein the system includes two or more nodes,
a first one of the two or more nodes includes a first electrical current sensor, a first local area network (LAN) bridge for communicating with other nodes, and a wider area network (WAN) bridge for communicating with the event logging server; and
a second one of the two or more nodes includes a second electrical current sensor and a second local area network (LAN) bridge for communicating with other nodes.

4. The system of claim 1, wherein the interface is a configurable web application.

5. The system of claim 1, wherein the power usage information includes one or more of measured current flow, ON switching events, OFF switching events, number of ON/OFF switching events, times of the ON/OFF switching events, duration of ON/OFF switching states and profiling information based on particular power signatures associated with electric-powered devices.

6. The system of claim 1, wherein the processing engine determines one or more of a change in activity patterns of the individual, an increase or decrease in the activity of the individual, a magnitude of variability in use of electronic technologies, an interval of time between activities of the individual and mobility of the individual in the living quarters.

7. The system of claim 1, wherein the processing engine generates a graphical representation of one or more of recent switching events, a summary of events, a change in activity patterns of the individual, an increase or decrease in the activity of the individual, a magnitude of variability in use of electronic technologies, an interval of time between activities of the individual and mobility of the individual in the living quarters.

8. The system of claim 7, wherein the graphical representation is displayed using the interface.

9. The system of claim 1, wherein the one or more nodes include an inline light bulb power sensor that is installed between a standard light socket and a light bulb.

10. The system of claim 1 wherein the one or more nodes include a power sensor inline with a modular battery in a cordless appliance.

11. A method for monitoring one or more activities of an individual, the method comprising:
receiving monitoring data from one or more nodes collecting power usage information at a living quarters of the individual;
determining actual activities of the individual based on the monitoring data;
receiving notification request for one or more of the actual activities of the individual;
receiving information about or specification of one or more expected activities for the individual;
comparing the actual activities to the one or more expected activities; and
generating a notification based on the comparing or the notification request.

12. The method of claim 11, further comprising:
detecting, based on the comparing, a disparity between the actual activities and the one or more expected activities,
wherein the notification is associated with the detected disparity.

13. The method of claim 12, further comprising:
receiving one or more notification threshold levels;
comparing the disparity to the one or more notification levels prior to generating the notification associated with the disparity.

14. The method of claim 13, further comprising:
determining, using the monitoring data, a sharp increase in power draw associated with an appliance; and
readjusting a notification threshold levels associated with the appliance to account for the sharp increase.

15. The method of claim 11, wherein the notification indicates that the power usage information matches the one or more expected activities such that no disparity is identified.

16. The method of claim 11, wherein the power usage information includes one or more of measured current flow, ON switching events, OFF switching events, number of ON/OFF switching events, times of the ON/OFF switching events, duration of ON/OFF switching states and profiling information based on particular power signatures associated with electric-powered devices.

17. The method of claim 16, further comprising:
analyzing the number of and a duration between the ON/OFF switching events to determine one or more machine-initiated switching events; and
filtering the one or more machine-initiated switching events from the number of ON/OFF switching events to determine switching events initiated by the individual.

18. The method of claim 11, further comprising:
determining, using the monitoring data, one or more of a change in activity patterns of the individual, an increase or decrease in the activity of the individual, a magnitude of variability in use of electronic technologies, an interval of time between activities of the individual and mobility of the individual in the living quarters.

19. The method of claim 11, further comprising:
determining, based on the monitoring data, that a thermostat-based electrical appliance is switched off.

20. A non-transitory computer-readable storage medium storing one or more instructions that, when executed on a processor, cause the processor to:
receive monitoring data from one or more nodes collecting power usage information at a living quarters of an individual;
determine actual activities of the individual based on the monitoring data;
receive notification request for one or more of the actual activities of the individual;
receive information about or specification of one or more expected activities for the individual;
compare the actual activities to the one or more expected activities;
detect, based on the comparing, a disparity between the actual activities and the one or more expected activities;
compare the disparity to the one or more notification levels prior to generating the notification associated with the disparity; and
generate, based on the comparing or the notification request, a notification associated with the disparity.
